(19) United States
(12) Patent Application Publication
(10) Pub. No.: US 2005/0245159 A1
(43) Pub. Date: Nov. 3, 2005

(54) Breathable barrier composite with hydrophobic cellulosic fibers

(76) Inventors: Harry J. Chmielewski, Brunswick, GA (US); Karl D. Sears, Heber City, UT (US); Michael E. Haeussler, Savannah, GA (US); Jay Taylor, Pooler, GA (US); Tina R. Murguia, Surrency, GA (US); Andrew S. Burnes, Dover, DE (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 11/055,100

(22) Filed: Feb. 11, 2005

Related U.S. Application Data
(60) Provisional application No. 60/543,390, filed on Feb. 11, 2004.

(51) Int. Cl. B32B 21/02; B32B 5/26; B32B 27/32

(52) U.S. Cl. 442/268; 442/330; 442/414; 442/416; 442/417; 442/398; 442/408; 442/382; 442/385; 442/394; 604/366; 604/367; 604/374; 156/296; 264/109; 8/116.1

(57) ABSTRACT

A breathable barrier composite of cellulosic fibers includes a compressed mixture of hydrophobic cellulosic fibers and thermally-bondable polyolefin fibers. The composite has a combination of high liquid barrier properties, and high air and moisture vapor porosity. The composite also has a very soft and cottony texture. The breathable barrier composite may optionally contain a nonwoven layer, such as a spunbond or an SMS nonwoven, a polyolefin film layer, or a nonwoven wipe layer.

The present invention claims priority to U.S. Provisional Application No. 60/543,390 filed Feb. 11, 2004, the contents of which are incorporated herein by reference in their entirety.

### BACKGROUND OF THE INVENTION

1. Field of the Invention

The present invention relates to a liquid barrier composite suitable for use in hygiene and medical products.

2. Description of Related Art

In general, disposable absorbent product constructions comprise, from the skin-facing side outwardly, an inner topsheet that is liquid-permeable to facilitate entry of the fluid exudate from the wearer into the construction, a core of highly absorbent material for absorbing fluid received through the topsheet, and an outer backsheet formed of a vapor- and liquid-impermeable plastic to eliminate leakage of fluid from the diaper. The backsheet has traditionally been made from plastic films due to cost considerations and the liquid impermeable nature of plastic films. While plastic films are efficient at containing liquids and other waste matters during use, the same plastic films have certain disadvantages in that they are not pleasing to the touch and they do not readily pass water vapor, so that, from a wearer wellness standpoint, plastic films tend to cause skin hydration thereby making infants more prone to diaper rash.

One solution has been to replace nonporous plastic films with breathable plastic films as the absorbent product backsheet. There are a number of ways of making a film breathable, including aperturing and the use of fillers. A particularly useful film for such applications is made from a linear polyolefin containing organic and/or inorganic fillers. Such filled polyolefin films provide good water vapor transmission while maintaining liquid barrier properties.

Breathable films currently used in some premium baby diapers typically exhibit a mass vapor transmission rate (“MVTR”) value in the range of 2000 to 5000 g/m²/24 hrs and a hydrostatic barrier of >40 cm water. These films, however, have no measurable air porosity, which can result in an increase in skin temperature and hydration, and lead to physical discomfort during extended periods of wear. In addition, such breathable films have the disadvantage of being cold and clammy because breathable films pass moisture to the outside of the product where it condenses readily on the film surface.

Fibrous nonwoven webs, when used as the backing material for diapers, alleviate the above-mentioned film problems by providing a measurable air porosity and a high MVTR, however such fibrous nonwoven webs generally provide poor barrier properties to the passage of liquids including urine. As a result, most nonwovens, by themselves, are not suitable as backing materials. Some fibrous nonwoven webs repel liquids better than others, especially when they include a layer of fine fiber nonwoven material such as a layer of meltblown. Even with the use of meltblown layers, however, such fibrous nonwovens do not always prove to be totally suitable as a backing material for personal care products.

In view of the foregoing deficiencies of both films and fibrous nonwovens, attempts have been made to combine the two materials in an effort to rely upon the strengths of one material to overcome the weaknesses of the other. However, the combinations of these materials have been equally unsuccessful at providing high liquid barrier properties and high air porosity.

Various other combinations of materials have been attempted to achieve these benefits. For instance, U.S. Pat. No. 4,904,520 to Dumas, the disclosure of which is incorporated herein by reference in its entirety, discloses a material that provides liquid barrier properties, and gas permeability that can be produced by a wet forming process without requiring a water-repellant surface treatment or lamination. More specifically, Dumas discloses a wet laid nonwoven material comprising a thermally consolidated blend of two different polyolefin pulps and a staple fiber. However, at 10% wood pulp content, the material disclosed has a relatively low air porosity of about 15.1 cubic feet per minute to achieve the desired liquid impermeability.

U.S. Pat. No. 5,534,340 to Gupta, the disclosure of which is incorporated herein by reference in its entirety, discloses a liquid barrier fabric providing liquid barrier properties and high air permeability. Gupta relates to a nonwoven material comprising at least one carded and thermally consolidated layer consisting of at least 10% fibers that are preferably hydrophobic. Although the fabric is relatively air permeable (it has a permeability greater than 80 cubic feet per minute), the fabric has a liquid strike-through resistance of less than 300 mm water, which is less than a typical 40 g/m² spunbond-meltblown-spunbond (SMS) nonwoven.

The description herein of advantages and disadvantages of known breathable barrier materials is not intended to limit the scope of the present invention. Indeed, the present invention may include some or all of the attributes described above.

### SUMMARY OF THE INVENTION

In view of the disadvantages of the known breathable barrier materials, there still exists a need for a breathable liquid barrier material that can provide a combination of high liquid barrier properties with high moisture vapor and air porosity. The resultant breathable barrier material also preferably has a soft cloth-like feel and is suitable for use in absorbent articles, surgical drapes and garments, wipes, and other products.

One aspect of the claimed invention is to provide a breathable barrier composite comprising a cellulosic fiber layer. The cellulosic fiber layer includes about 80% to 90% by weight of a hydrophobic pulp fiber, and 10 to 20% by weight of a thermally bondable fiber. The cellulosic fiber layer has an overall basis weight of 25-80 grams/m².

Another aspect of the claimed invention is to provide a breathable barrier composite that has a cellulosic fiber layer and a nonwoven layer. The cellulosic fiber layer has a basis weight of about 25-50 g/m² and includes about 80% to 90% by weight of a hydrophobic pulp fiber, and 10 to 20% by weight of a thermally bondable fiber. The cellulosic fiber layer is operably associated with the nonwoven layer, which has a basis weight of about 13-26 g/m².

Another aspect of the claimed invention is to provide a soft, cloth-like barrier composite that has a cellulosic fiber layer and a polyolefin film layer. The cellulosic fiber layer has a basis weight of about 10-30g/m², and includes about 80% to 90% by weight of a hydrophobic pulp fiber, and 10 to 20% by weight of a thermally bondable fiber. The polyolefin film layer has a basis weight of about 13-26 g/m².

Another aspect of the claimed invention is to provide a hydrophobic fibrous material by providing cellulosic fibers, and applying a hydrophobic fiber treatment to the cellulosic fibers to produce hydrophobic cellulosic fibers. The hydrophobic cellulosic fibers may be used to form a breathable barrier composite.

These and other objects, features and advantages of the present invention will appear more fully from the following detailed description of the preferred embodiments of the invention, and the attached drawings.

### BRIEF DESCRIPTION OF THE DRAWINGS

FIG. 1 is a sectional view of a preferred embodiment in which the breathable composite is formed from two layers.

### DETAILED DESCRIPTION OF PREFERRED EMBODIMENTS

Preferred embodiments of the present invention may be employed as cloth-like, breathable liquid barrier composites suitable for use in hygiene and medical products such as baby diapers, incontinence garments, feminine hygiene articles, surgical gowns, surgical drapes, surgical face masks and the like. The inventive composites advantageously provide a liquid barrier while being highly vapor porous. The breathable barrier composites of the preferred embodiments have an air porosity comparable to that of a knitted cotton fabric, while maintaining liquid barrier properties sufficient to support a hydrostatic pressure of 25-40 cm saline. The high vapor porosity allows the breathable liquid barrier composites to provide occlusive products with improved levels of in-use comfort. In addition, the inventive composites provide unexpectedly high levels of cotton-like softness and cloth-like feel.

In particular preferred embodiments of the present invention, the breathable liquid barrier composite is a cellulosic fiber layer that is primarily made of a hydrophobic cellulosic fiber combined with a thermally-bondable bicomponent polyester fiber. Suitable cellulosic fibers used in the cellulosic fiber layer of the breathable liquid barrier include those primarily derived from wood pulp. Fibers may be obtained from various hardwoods or softwoods, however it is preferred that the cellulosic fiber layer is made from hardwood pulp fibers, such as SULFATATE® grade fibers commercially available from Rayonier, Inc. of Jesup, Ga. Other suitable fibers such as eucalyptus and cotton linter fibers may also be used to form the cellulosic fiber layer. The cellulosic fiber layer may also be made from a mixture of two or more of the foregoing cellulose pulp products.

The cellulosic fibers used in this invention may be made moderately hydrophobic by one of several treatments. One suitable type of treatment involves the application of a polymeric sizing agent such as alkyl ketene dimer (“AKD”). AKD sizing agents are typically cationic and designed for wet-end applications to wood pulp fibers. They are principally designed to react (or “cure”) under normal drying conditions (˜195 ° F.) with paper or paperboard fibers, resulting in covalent bonds (ester linkages) and a stable, hydrophobic material. Other suitable hydrophobic fiber treatments include other paper sizing agents based on synthetic polymers, as well as natural oils and waxes such as, for example, linseed oil, stearic, isostearic, and behenic acids, and beeswax. Fluorinated polyacrylates and polysiloxanes may also be used to treat the cellulose fibers and make them sufficiently hydrophobic.

Preferably, the cellulosic fibers of the present invention are given a hydrophobic treatment in a separate process before being airlaid to form the cellulosic fiber layer. For example, the sizing agents may be applied to a wet slurry of fibers (see Example 1) prior to formation of the cellulosic fiber layer.

Optionally, cellulosic fibers in roll or sheet form may be treated using dilute solutions of an AKD sizing agent that uniformly saturates the pulp sheet, and then pressed to remove excess fluid, and dried at the appropriate temperature (about 190-200 ° F.). This same process may be used to make rolls of hydrophobic fluff from either hardwood or softwood fibers. Roll stock of hydrophobic fibers may then be passed through a hammermill and processed on conventional airforming equipment used in making baby diapers, feminine napkins, and adult incontinence products. It has been found that preparing hardwood or softwood pulp in this manner produces fluff fibers with a level of accepts greater than about 75% in the Johnson Classifier test (see test method below).

The hydrophobic fibers of the cellulosic fiber layer are mixed with thermally-bondable fiber. The thermally-bondable fiber may be selected from a variety of polyolefin fibers, such as polypropylene, polyethylene, and polyester fibers, or it may consist of a blend or mixture of polyolefin fibers. Preferably the thermally bondable fiber is a bicomponent fiber, such as a polythylene-polypropylene bicomponent fiber. The thermally bondable fiber preferably has a denier of about 3-9, more preferably about 4-8 denier, and most preferably about 6 denier. The thermally bondable fiber preferably forms about 10-20% by weight of the fiber mixture, more preferably it forms about 12-18% of the fiber mixture, and most preferably about 14-16% of the fiber mixture in the cellulosic fiber layer. Typical basis weights for the cellulosic fiber layer are about 40 to 80 g/m².

After the fibers have been mixed, the cellulosic fiber layer is compressed using sufficient heat and pressure to develop the desired pore size distribution in the cellulosic fiber layer to impart the desired liquid barrier properties and air porosity. The fiber layer may be compressed, for example, by any conventional or later-conceived methods, such as by using a standard heated calendar roll process. Preferably, the calendar roll process is operated at temperatures within the range of about 100° C. to 500° C. and at pressures within the range of about 1,000 psi to 80,000 psi. It has been found that higher temperature, higher pressure, and longer press times produce composites that have higher liquid barrier properties but lower air porosities.

It is preferred that the compressed cellulosic fiber layer has a density of greater than about 0.2 g/cc, and more preferably greater than about 0.5g/cc.

In some embodiments, a particulate adhesive or thermally-bondable poly-olefin powder may also be dispersed throughout the fiber mixture prior to being compressed. The addition of such a material or other materials like it, may help to control the pore size distribution and air porosity of the cellulosic fiber layer.

When made in accordance with the present invention, the breathable barrier composite has a superior combination of liquid barrier properties, breathability, and air porosity properties. Table 1 below shows typical test data for a 60 g/m² breathable barrier composite of the present invention compared to a commercial breathable film and a knitted cotton fabric of the weight used in the construction of men's t-shirts. The results below show that knitted cotton fabrics exhibit very high air porosity and mass vapor transmission, but exhibit essentially no liquid barrier properties (as measured by the hydrostatic pressure test). On the other hand, commercially available breathable films, such as, CELGARD® films manufactured by Hoechst Celanese Corporation of Sommerville, N.J., exhibit good liquid barrier properties, and relatively good mass vapor transmission, but have essentially no air porosity or permeability. In comparison, the breathable barrier composite of the present invention provides high air porosity and mass vapor transmission, as well as high liquid barrier properties.

TABLE 1

| | | | Knitted |
|---|---|---|---|
| | Commercial | Breathable Barrier | Cotton |
| | Breathable Film | Composite (60 gsm) | Fabric |
| Hydrostatic | >40 | 25-40 | 0 |
| Pressure Test (cm) | | | |
| Air Porosity Test | 0 | >60 | 80 |
| (ft3/ft2/min) | | | |
| MVTR Test | 5000 | >8000 | >8000 |
| (g/m²/24 hrs) | | | |

In addition to the superior liquid barrier and air porosity properties, it has been discovered that the breathable barrier composite of the present invention also exhibits superior tactile properties. The cellulosic fiber layer also provides a soft, cottony, cloth-like texture.

Once formed, the breathable barrier composite, can be used for a wide variety of applications, and is particularly suited for use in absorbent articles such as diapers and adult incontinence products, where softness and liquid barrier properties are highly desirable. Such articles typically include a body side liner, an absorbent core and a backsheet layer or an outer cover. When used this way, the breathable liquid barrier will typically be oriented on the exterior surface (as opposed to the body-facing surface) of the absorbent article so that it contains liquid within the absorbent article, and protects the outer garments from the absorbed moisture. The backsheet layer may be bonded to the body side liner and/or other components of the absorbent article. When used as a backsheet in an absorbent article, the breathable barrier composite provides an effective breathable liquid barrier in addition to a soft, cloth-like exterior surface that makes the product feel more garment-like.

The breathable barrier composite of the present invention is also particularly suitable for use in surgical gowns and drapes, where the composite forms a barrier to the transmission of biological liquids and contaminants, and the softness and breathability of the barrier composite provide superior comfort to the wearer.

The breathable barrier composite of the present invention may also be laminated to a wet wipe, for use as a dry backing layer. Wet wipe applications include, for example, baby wipes, hand wipes, face wipes, cosmetic wipes, household wipes, industrial wipes, and so on. When used as a backing layer for wet wipes, it has been found that the breathable barrier composite layer provides a dry surface for a user to hold, while the opposed surface of the laminate remains wet. Materials suitable for such wet wipes are well known to those skilled in the art. The wet wipes are typically made from woven or nonwoven fibrous sheet materials. For example, the wet wipes may include nonwoven fibrous sheet materials which include meltblown, coform, air-laid, bonded-carded web materials, hydroentangled materials, combinations thereof, and the like. Such materials can comprise synthetic or natural fibers or combinations thereof. Typically, the wet wipes have a basis weight of from about 25 to about 120 g/m² and more preferably from about 40 to about 90 g/m². The breathable barrier composite may be laminated or bonded to one surface of the wipe using any conventional or later-developed method that can create a bond sufficient to keep the two materials together during typical storage and use conditions.

In addition to their usefulness as components of breathable barrier composites, the hydrophobic cellulosic fibers as prepared according to the present invention have other useful applications in absorbent product design. For example, because of their hydrophobic properties, the cellulosic fibers are suited for leakage barriers in an absorbent article. In particular embodiments, the hydrophobic cellulosic fibers are selectively placed in absorbent articles in the waist region or the leg region to provide effective liquid leakage barriers.

Similarly, the hydrophobic cellulosic fibers of the present invention may be effective at providing leakage protection caused by pinhole defects in a backsheet of an absorbent article. In one aspect of the invention, the hydrophobic cellulosic fibers are used as a dusting layer adjacent to a backsheet composite to help provide additional liquid barrier function. For example, U.S. Pat. No. 4,888,231 to Angstadt, incorporated herein by reference, discloses an absorbent article having an air-laid absorbent core that contains a dusting layer of hydrophilic fibers. In contrast, the dusting layer of this particular embodiment of the present invention includes hydrophobic fibers, which, when selectively placed adjacent to the backsheet layer, provide an additional liquid barrier layer. The hydrophilic fiber dusting layer of Angstadt does not perform this additional barrier function. In accordance with this aspect of the invention, it is preferable that the fibers of the dusting layer are present in an amount that is about 50 to 100 g/m².

In certain low-cost applications, it may desirable to reduce the basis weight of the cellulosic fiber layer, to reduce overall product cost. However, a reduction in basis weight of the cellulosic layer also results in a reduction in the tensile and tear properties of the substrate. It may therefore be necessary to laminate the cellulosic fiber layer to a support layer such as a nonwoven sheet to maintain the strength of the material for processing or other reasons, without significantly changing the air porosity or breathability of the material. Thus, in particular aspects of the invention, a breathable liquid barrier composite is made of two layers.

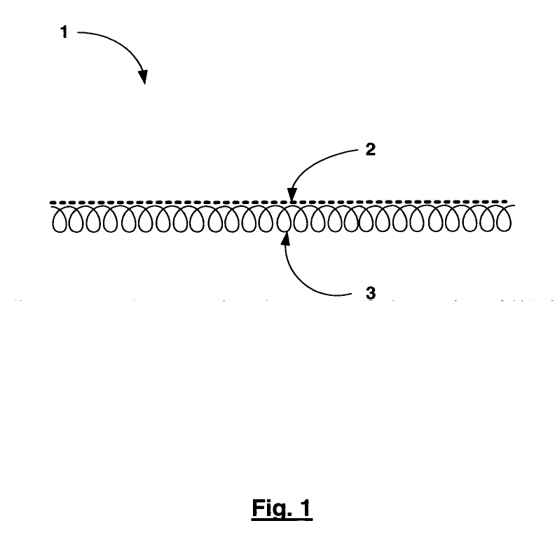

Referring to FIG. 1, a breathable liquid barrier 1 made in accordance with one preferred embodiment includes a cellulosic fiber layer 3, and a nonwoven layer 2. The nonwoven layer 2 is preferably a nonwoven substrate capable of providing the breathable barrier composite 1 with moderate tear strength for in-use applications and tensile strength for processability without imparting stiffness or a harsh, paper-like feel to the composite 1. For example, the nonwoven layer 2 may be a spunbonded, resin-bonded, through-air bonded or an SMS (spunbonded-meltblown-spunbonded) nonwoven that has a basis weight in the range of about 13 to 26 g/m². A hot melt or latex-type adhesive is applied to the nonwoven layer 2 during construction of the composite to help prevent delamination of the layers. When used in combination with the second nonwoven layer 2, the cellulosic fiber layer 3 may have a basis weight in the range of 25 to 50 g/m², and still maintain its liquid barrier properties. Therefore, the basis weight of the overall two-layer breathable liquid barrier composite 1 is typically in the range of 40 to 80 g/m².

In another aspect of the invention, a breathable barrier composite that is made from a two-layer laminate may be used in an absorbent article as an outer cover or backsheet. In accordance with this aspect of the invention, it is preferable that the inner surface (the surface facing the absorbed and contained liquid) is the nonwoven layer, and that the outer surface is the cellulosic fiber layer, so that it may provide a cloth-like exterior surface for the product.

In certain applications, softness and cost may be more desirable than breathability or air porosity. Because the cellulosic fiber layer has exhibited superior aesthetics with regard to its softness and feel, it may be desirable to combine a lower-basis weight cellulosic fiber layer that does not have good barrier properties, with a low-cost barrier material, such as a polymeric film. Although this type of composite may not have appreciable breathability, it maintains the soft, cloth-like aesthetics of the breathable barrier composite and has a potential for lower raw material cost because of the reduced basis weight of the cellulosic fiber layer. Accordingly, in one aspect of the invention, a cellulosic fiber layer is bonded to a polyolefin film substrate to form a soft, cloth-like barrier composite. The polyolefin film preferably has a basis weight in the range of 13 to 26 g/m². The film may be made of any suitable polyolefin film substrates, but is preferably a polyethylene or polypropylene film. In accordance with this aspect of the invention, the cellulosic fiber layer is preferably made from 80% to 90% by weight of softwood cellulosic fibers, and 10% to 20% by weight of thermally-bondable fibers. The basis weight of the cellulosic fiber layer is preferably in the range of 10 to 30 g/m².

Test Methodology

A measure of liquid barrier performance of the breathable composite was obtained in the Hydrostatic Pressure Test. This test measures the height of a column of saline that can be supported by one layer of the composite.

The test apparatus has a 60 mm wide cylinder and two 145 mm flanges each having a 60 mm hole in the center to hold a sample. Samples were cut to about 3.5 in. ×3.5 in. With a sample in place, saline was pumped into the bottom of the cylinder below the sample at a rate of 3 cm/min. A length of ⅛ in. Tygon tubing leading from the bottom of the cylinder was clamped to a calibrated rule in a vertical position along side the cylinder to record hydrostatic head pressure in centimeters. Failure in this test was defined as the observation of three pin holes or leaks on the exterior surface of the sample. The height of the liquid column was recorded at failure. At least three replicates were run for each sample.

The air porosity, or permeability, of the breathable barrier composites were measured according to ASTM D1682-64 using a Frazier Air Permeometer obtained from Frazier Precision Instrument Co., Hagerstown, Md. The Air Porosity Test measures the flow of air through a sample using an air pressure of 0.5 inches of water.

The mass vapor transmission rate, or MVTR, was measured according to ASTM Standard E96-95.

The Johnson Classifier tests were carried out on a Fluff Fiberization Measuring Instrument (Model 9010, Johnson Manufacturing, Inc., Appleton, Wis., USA), which is used to measure knots, nits and fine contents of fibers. In this instrument, a sample of fibers in fluff form was continuously dispersed in an air stream. During dispersion, loose fibers passed through a 16 mesh (1.18 mm) screen and then through a 42 mesh (0.36 mm) screen. Pulp bundles (knots) which remained in the dispersion chamber and those that were trapped on the 42-mesh screen were removed and weighed. The former are called “knots” and the latter “accepts.” The combined weight of these two is subtracted from the original weight to determine the weight of fibers that passed through the 0.2 mm screen. These fibers are referred to as “fines”.

### EXAMPLES

### Example 1

### Preparation of Hydrophobic Cellulosic Fiber of the Breathable Barrier Composite

Hercules HERCON® 79 reactive sizing (0.97 g “as-is”) was added to a slurry (˜2 L) of never-dried Rayonier SULFATATE®-H-J purified hardwood cellulose fibers (50 g o.d.) and slurried for 5 minutes. A retention aid was then added (0.1 g of Hercules PERFORM™PA8137 diluted with water) and slurrying was continued for five more minutes prior to transferring the fibrous suspension to a sheet-making mold. After draining water from the sheet, it was blotted and then pressed (twice at 75 psi) to remove excess water. The sheet was then dried for 20 minutes in an Emerson drier set at about 275 ° F., and then placed in a forced air oven set at 195 ° F. and dried for an additional 10 minutes. Strips of the dried pulp sheet readily floated when placed in water.

### Example 2

### Preparation of a Breathable Barrier Composite

Hydrophobic fiber in sheet form (as made by the method of Example 1) was defiberized in a Kamas hammermill to produce hydrophobic pulp fibers. The conditions of operation of the hammermill were 4200 rpm, 4 mm reject screen, and 4 cm/sec sheet feed speed. Fifteen percent of a 6 denier, 0.25 mm length bicomponent fiber (FiberVisions Intack-S 75/25 PE:PP) was mixed with the hydrophobic pulp fibers in a laboratory handsheet former and airlaid onto a 15 g/m² hydrophobic SMS nonwoven. A small amount (<3%) of a particulate filler (ELVALOY®, an EVA polymer commercially available from E.I. DuPont de Nemours and Company, Wilmington, Del.) was added to adjust porosity. The airlaid handsheet was placed in a heated (300° C.) Carver flat press at 1000 psi for 15 seconds.

While the present invention has been described and illustrated herein with reference to various preferred embodiments it should be understood that these embodiments are exemplary only, and the present invention is limited only by the following claims. Furthermore, to the extent that the features of the claims are subject to manufacturing variances or variances caused by other practical considerations, it will be understood that the present claims are intended to cover such variances.

1. A breathable barrier composite comprising:
a cellulosic fiber layer comprising from about 80% to about 90% by weight hydrophobic wood pulp fibers and from about 10% to about 20% by weight thermally-bondable fibers;
wherein the breathable barrier composite has a basis weight of from about 25 to about 80 grams/m².

2. The breathable barrier composite of claim 1, wherein the hydrophobic wood pulp fibers are derived from fibers selected from the group consisting of: hardwood pulp fibers, softwood pulp fibers, eucalyptus fibers, cotton linter fibers and combinations and mixtures thereof.

3. The breathable barrier composite of claim 1, wherein the hydrophobic wood pulp fibers are derived from hardwood pulp fibers.

4. The breathable barrier composite of claim 1, wherein the thermally-bondable fiber is a polyester.

5. The breathable barrier composite of claim 1, wherein the thermally-bondable fiber is a bicomponent fiber.

6. The breathable barrier composite of claim 5, wherein the thermally-bondable fiber is a polyethylene-polypropylene bicomponent fiber.

7. The breathable barrier composite of claim 1, wherein the thermally-bondable fiber has a fiber denier of about 3 to about 9.

8. The breathable barrier composite of claim 1, wherein the thermally-bondable fiber has a fiber denier of about 4 to about 8.

9. The breathable barrier composite of claim 1, wherein the thermally-bondable fiber has a fiber denier of about 6.

10. The breathable barrier composite of claim 1, wherein the cellulosic fiber layer comprises from about 12% to about 18% by weight thermally-bondable fibers.

11. The breathable barrier composite of claim 1, wherein the cellulosic fiber layer comprises from about 14% to about 16% by weight thermally-bondable fibers.

12. The breathable barrier composite of claim 1, wherein the cellulosic fiber layer has a compressed density of at least about 0.2 g/cm³.

13. The breathable barrier composite of claim 1, wherein the cellulosic fiber layer has a compressed density of at least about 0.5 g/cm³.

14. The breathable barrier composite of claim 1, wherein the cellulosic fiber layer further comprises a particulate adhesive or a poly-olefin powder or a combination or mixture thereof.

15. The breathable barrier composite of claim 1, wherein the breathable barrier composite is liquid impermeable up to a hydrostatic pressure of about 25 cm water to about 40 cm saline.

16. The breathable barrier composite of claim 1, wherein the breathable barrier composite has an air porosity of at least about 60 ft³/ft²/minute.

17. The breathable barrier composite of claim 1, wherein the breathable barrier composite has a mass vapor transmission rate (MVTR) of at least about 8000 g/m²/24 hours.

18. The breathable barrier composite of claim 1, further comprising an additional layer selected from the group consisting of: a spunbonded nonwoven, a resin-bonded nonwoven, a thru-air bonded nonwoven, a meltblown nonwoven, a spunbonded-meltblown-spunbonded (SMS) nonwoven, a polyolefin film, a nonwoven wipe, a tissue and combinations and fragments thereof.

19. An absorbent article comprising a backsheet, a topsheet, and an absorbent core disposed at least partially between the backsheet and the topsheet; wherein said absorbent article comprises the breathable barrier composite of claim 1.

20. The absorbent article of claim 19, wherein the backsheet comprises, at least in part, the breathable barrier composite.

21. The absorbent article of claim 19, comprising a leakage barrier in a leg region, wherein the leakage barrier comprises, at least in part, the breathable barrier composite.

22. The absorbent article of claim 19, comprising a leakage barrier in a waist region, wherein the leakage barrier comprises, at least in part, the breathable barrier composite.

23. A wipe comprising the breathable barrier composite of claim 1.

24. The wipe of claim 23, comprising a wet wipe layer laminated on one surface to a backing layer, wherein the backing layer comprises, at least in part, the breathable barrier composite.

25. The wipe of claim 24, wherein the wet wipe layer has a basis weight of about 25 to about 120 g/m².

26. The wipe of claim 24, wherein the wet wipe layer has a basis weight of about 40 to about 90 g/m².

27. The wipe of claim 25, wherein the wet wipe layer comprises a woven fibrous material.

28. The wipe of claim 24, wherein the wet wipe layer comprises a nonwoven fibrous material.

29. The wipe of claim 28, wherein the nonwoven fibrous sheet material is selected from the group consisting of: a meltblown, a coform, an air-laid, a bonded-carded web, a hydroentangled material, and combinations and fragments thereof.

30. The wipe of claim 24, wherein the wet wipe layer is comprised of natural fibers or synthetic fibers or a combination thereof.

31. The wipe of claim 24, wherein the breathable barrier composite is laminated to one surface of the wet wipe layer.

32. The breathable barrier composite of claim 1 further comprising:
a nonwoven layer operatively associated with the cellulosic fiber layer, said nonwoven layer having a basis weight of about 13 to about 26 grams/m²;
wherein the cellulosic fiber layer has a basis weight of about 25 to about 50 grams/m².

33. A soft, cloth-like barrier composite comprising:
a polyolefin film substrate having a basis weight of about 13 to about 26 grams/m²; and
a cellulosic fiber layer having a basis weight of about 10 to about 30 grams/m², said cellulosic fiber layer comprising from about 80% to about 90% by weight hydrophobic wood pulp fibers and from about 10% to about 20% by weight thermally-bondable fibers.

34. An absorbent article comprising a backsheet, a topsheet, and an absorbent core disposed at least partially between the backsheet and the topsheet; wherein said absorbent article comprises the cloth-like barrier composite of claim 33.

35. The absorbent article of claim 34, comprising a backsheet, wherein the backsheet comprises, at least in part, the cloth-like barrier composite.

36. The absorbent article of claim 34, comprising a leakage barrier in a leg region, wherein the leakage barrier comprises, at least in part, the cloth-like barrier composite.

37. The absorbent article of claim 34, comprising a leakage barrier in a waist region, wherein the leakage barrier comprises, at least in part, the cloth-like barrier composite.

38. A method of producing a hydrophobic fibrous material comprising:
providing cellulosic fibers; and
treating the cellulosic fibers by applying a hydrophobic fiber treatment agent to the cellulosic fibers to produce hydrophobic cellulose fibers.

39. The method of claim 38, wherein the cellulosic fibers comprise fibers selected from the group consisting of: hardwood pulp fibers, softwood pulp fibers, eucalyptus fibers, cotton linter fibers and combinations and mixtures thereof.

40. The method of claim 38, wherein the cellulosic fibers are hardwood pulp fibers.

41. The method of claim 38, wherein the hydrophobic fiber treatment agent comprises alkyl ketene dimer.

42. The method of claim 38, wherein the hydrophobic fiber treatment agent comprises a paper sizing agent based on one or more synthetic polymers.

43. The method of claim 38, wherein the hydrophobic fiber treatment agent comprises a natural oil or wax selected from the group consisting of: linseed oil, stearic acid, isostearic acid, behenic acid, beeswax, and combinations and mixtures thereof.

44. The method of claim 38, wherein the cellulosic fibers are provided in a wet slurry.

45. The method of claim 38, wherein the cellulosic fibers provided in an airlaid web.

46. The method of claim 38, wherein the cellulosic fibers are provided in a pulp sheet that is in roll or sheet form.

47. Hydrophobic fibrous material made according to the method of claim 38.

48. An absorbent article comprising a backsheet, a topsheet and an absorbent core at least partially disposed between the backsheet and the topsheet; wherein said absorbent article comprises the hydrophobic fibrous material of claim 47.

49. The absorbent article of claim 48, wherein the absorbent core comprises a dusting layer adjacent to the backsheet, and wherein said dusting layer comprises a layer of the hydrophobic fibrous material having a basis weight of from about 50 g/m² to about 100 g/m².

50. The method of claim 38, further comprising:
providing thermally-bondable fibers;
combining the hydrophobic cellulosic fibers and the thermally-bondable fibers to produce a cellulosic fiber layer comprising from about 80% to about 90% by weight hydrophobic cellulosic fibers and from about 10% to about 20% by weight thermally-bondable fibers; and
compressing the cellulosic fiber layer so that the compressed cellulosic fiber layer has a density of at least about 0.2 g/cm³.

51. The method of claim 50, wherein the hydrophobic cellulosic fibers are provided in a pulp sheet that is in roll or sheet form; and wherein said method further comprises fiberizing the hydrophobic cellulosic fibers.

52. The method of claim 50, wherein compressing the cellulosic fibrous layer comprises compressing the cellulosic fibrous layer with a heated calender roll process operated at a temperature within the range of about 100° C. to about 500° C. and at a pressure within the range of about 1,000 psi to about 50,000 psi.
